(19) United States
(12) Patent Application Publication
(10) Pub. No.: US 2026/0140002 A1
(43) Pub. Date: May 21, 2026

(54) AUXETIC FORCE SENSOR

(71) Applicant: The Board of Regents for the Oklahoma Agricultural and Mechanical Colleges, Stillwater, OK (US)

(72) Inventors: Chulho Yang, Stillwater, OK (US); Huaxia Wang, Glassboro, NJ (US); Brandon Dang, Stillwater, OK (US)

(21) Appl. No.: 19/394,164

(22) Filed: Nov. 19, 2025

Related U.S. Application Data
(60) Provisional application No. 63/722,139, filed on Nov. 19, 2024.

(51) Int. Cl. G01L 1/22; G01L 1/26; G01L 5/00

(52) U.S. Cl. CPC G01L 1/2287; G01L 1/225; G01L 1/26; G01L 5/00

(57) ABSTRACT

An auxetic force-sensing resistor (“force sensor”) sensor system is disclosed suitable for manufacturing via common 3D printing methods like Fused Deposition Modeling (FDM) without extensive post-processing. The force sensor may comprise a plurality of interconnected cells, and may be at least partially constructed of an elastic conductive material, such as conductive TPU. Each cell may feature sidewalls that may be configured to collapse inwardly when a compressive force is applied to the cell's top or bottom. This inward collapse may create new, lower-impedance points of contact within the cell's structure, which may thereby reduce the sensor's overall electrical resistance in a controlled manner proportional to the applied force.

### CROSS-REFERENCE TO RELATED APPLICATIONS/INCORPORATION BY REFERENCE STATEMENT

The present patent application claims priority to the provisional patent application identified by U.S. Ser. No. 63/722,139, filed on Nov. 19, 2024, the entire contents of which is hereby incorporated by reference herein.

### STATEMENT REGARDING FEDERALLY SPONSORED RESEARCH OR DEVELOPMENT

Not applicable.

### BACKGROUND

Force sensors are prevalent in numerous practical designs and research endeavors. For example, an array of force sensors may be implemented in a car seat for ergonomic research and design. Such an array of force sensors may assist designers with identifying uneven weight distribution of a person sitting on a seat, potentially leading to discomfort or injury after prolonged periods of time.

One example of a force sensor is a piezoresistive force sensor. In a piezoresistive sensor, an electrical resistance of the sensor changes proportionally to mechanical stress. When a force is applied to a piezoresistive force sensor, the sensor undergoes a mechanical stress, such as a compression or stretching. By applying a voltage to the sensor, the change in resistivity of the sensor after the force is applied can be detected. The force applied to the sensor can then be calculated from the resulting change in resistivity.

However, some piezoresistive force sensors do not deform uniformly under stress, and thus do not have a relatively linear relationship between force and electrical resistance over the full measurement spectrum of the sensor. This complicates the force measurement, permitting further room for error.

Further, though many common piezoresistive force sensors can be developed by 3D printing methods, they often require load cell casing around the sensor or extensive post-processing after the print to give the device force-sensing capabilities.

### SUMMARY

Based on the foregoing, there exists a need for an improved piezoresistive force sensor having a predictable and relatively linear force-to-resistivity ratio and which may be developed by a common 3D printer without extensive post-processing treatment. It is to such an improved force sensor and applications thereof that the present disclosure is directed.

The following summary is a concise overview of the inventive concepts described herein, presented in compliance with 37 C.F.R. § 1.72. This summary may generally introduce the nature of the technical subject matter and should not be construed as limiting the scope of the disclosed implementations.

A force sensor is described herein. The force sensor may include a plurality of interconnected cells, wherein at least some of these cells may be partially or fully constructed from a conductive material that exhibits an elastic property. Each of these cells may include a top, a bottom, and at least one sidewall configured to collapse inwardly when a compressive force is applied to the cell's top or bottom. The conductive material of these cells may be electrically connected, allowing the compressive force to cause a corresponding change in the material's electrical resistance. To influence the resistance change, the sidewall may include portions that are hingedly connected to one another and/or to horizontal struts, such that different compressive forces may result in different contact patterns. The force sensor may utilize cells with different shapes, such as pluralities of first and second cells having distinct or identical shapes, which may be spatially arranged in overlapping planar arrays to potentially enhance measurement capabilities. The sidewall may also include a notch to promote inward collapse. For electrical isolation, some cells may be partially constructed of a non-conductive material to separate the conductive material of adjacent cells.

A measurement circuit may comprise a force sensor such as the force sensor described above. The circuit may also comprise an electrical source electrically coupled to the conductive material of the force sensor and a reader configured to measure the electrical resistance. The reader may be configured to correlate the measured resistance with a particular applied compressive force.

The disclosure also includes methods and a non-transitory computer readable medium for analyzing force data. The medium may comprise instructions that, when executed by a processor, may cause the processor to receive force signals from a sensor array (having a first resolution) and analyze these signals using a predetermined force distribution model to generate a force distribution map with a second resolution that may be greater than the first resolution. This force distribution map may be useful for applications such as indicating the weight distribution of a human in a car seat. The related method for generating a force distribution model may involve receiving force signals and analyzing them with an artificial intelligence model, such as a super resolution generative adversarial network. This artificial intelligence model may be trained using sample datasets which include low-resolution sensor data and corresponding high-resolution force distribution maps, which may be generated from the low-resolution sensor data using a spatial interpolation method such as the Kriging method.

### BRIEF DESCRIPTION OF THE DRAWINGS

FIG. 1. is a diagram of an exemplary measurement circuit in accordance with the present disclosure.

FIG. 2A is a front view of an auxetic force sensor having an exemplary 2D cell array in accordance with the present disclosure.

FIG. 2B is a front view of the auxetic force sensor of FIG. 2A in a compressed state in accordance with the present disclosure.

FIG. 3A is a front view of a first exemplary implementation of a cell shape of a cell of the 2D cell array in accordance with the present disclosure.

FIG. 3B is a front view of a second exemplary implementation of the cell shape of the cell of the 2D cell array in accordance with the present disclosure.

FIG. 3C is a front view of a third exemplary implementation of the cell shape of the cell of the 2D cell array in accordance with the present disclosure.

FIG. 3D is a front view of a fourth exemplary implementation of the cell shape of the cell of the 2D cell array in accordance with the present disclosure.

FIG. 3E is a front view of a fifth exemplary implementation of the cell shape of the cell of the 2D cell array in accordance with the present disclosure.

FIG. 4A is a front view of the 2D cell array of cells having the first exemplary implementation of the cell shape in accordance with the present disclosure.

FIG. 4B is a front view of the 2D cell array of cells having the second exemplary implementation of the cell shape in accordance with the present disclosure.

FIG. 4C is a front view of the 2D cell array of cells having the third exemplary implementation of the cell shape in accordance with the present disclosure.

FIG. 4D is a front view of the 2D cell array of cells having the fourth exemplary implementation of the cell shape in accordance with the present disclosure.

FIG. 4E is a front view of the 2D cell array of cells having the fifth exemplary implementation of the cell shape in accordance with the present disclosure.

FIG. 5A is a front perspective view of the force sensor having a first embodiment of a sensor body constructed in accordance with the present disclosure.

FIG. 5B is a rear perspective view of the force sensor having the first embodiment of the sensor body constructed in accordance with the present disclosure.

FIG. 6A is a front perspective view of the force sensor having a second embodiment of the sensor body constructed in accordance with the present disclosure.

FIG. 6B is a rear perspective view of the force sensor having the second embodiment of the sensor body constructed in accordance with the present disclosure.

FIG. 6C is a front perspective view of the non-conductive body of the second embodiment of the sensor body constructed in accordance with the present disclosure.

FIG. 6D is a rear perspective view of the non-conductive body of the second embodiment of the sensor body constructed in accordance with the present disclosure.

FIG. 6E is a front perspective view of the conductive body of the second embodiment of the sensor body constructed in accordance with the present disclosure.

FIG. 6F is a front perspective view of the conductive body of the second embodiment of the sensor body constructed in accordance with the present disclosure.

FIG. 6G is a front perspective view of the force sensor having the second embodiment of the sensor body without an outer conductive layer for demonstration in accordance with the present disclosure.

FIG. 6H is a rear perspective view of the force sensor having the second embodiment of the sensor body without the outer conductive layer for demonstration in accordance with the present disclosure.

FIG. 6I is a front perspective view of the force sensor having the second embodiment of the sensor body constructed in accordance with the present disclosure.

FIG. 6J is a cross-sectional view of the force sensor having the second embodiment of the sensor body taken along plane 6J-6J of FIG. 6I.

FIG. 7A is a perspective view of the force sensor having the first exemplary implementation of the cell of the 3D cell array constructed in accordance with the present disclosure.

FIG. 7B is the front view of the first exemplary implementation of the cell of the 2D cell array in accordance with the present disclosure.

FIG. 7C is a perspective view of a first exemplary implementation of a cell of a 3D cell array in accordance with the present disclosure.

FIG. 8A is a perspective view of the force sensor having the second exemplary implementation of the cell of the 3D cell array constructed in accordance with the present disclosure.

FIG. 8B is a front view of the third exemplary implementation of the cell of the 2D cell array in accordance with the present disclosure.

FIG. 8C is a perspective view of a second exemplary implementation of the cell of the 3D cell array in accordance with the present disclosure.

FIG. 9A is a top view of an exemplary force sensor array of a force mapping system constructed in accordance with the present disclosure.

FIG. 9B is a block diagram of the force mapping system in accordance with the present disclosure.

FIG. 10A is an exemplary force distribution map of signal data of the force sensor array at a first resolution in accordance with the present disclosure.

FIG. 10B is the exemplary force distribution map of the signal data of the force sensor array upscaled to a second resolution in accordance with the present disclosure.

FIG. 11A is an exemplary 10×10 force signal matrix in accordance with the present disclosure.

FIG. 11B is an exemplary 5×5 force signal matrix in a triangulation layout extracted from the matrix of FIG. 11A in accordance with the present disclosure.

FIG. 12A is an exemplary force distribution map extracted from the force signal matrix of FIG. 11A in accordance with the present disclosure.

FIG. 12B is an exemplary force distribution map extracted from the force signal matrix of FIG. 11B in accordance with the present disclosure.

FIG. 13 is an exemplary Super-Resolution Generative Adversarial Network in accordance with the present disclosure.

### DETAILED DESCRIPTION

Before explaining at least one embodiment of the inventive concept(s) in detail by way of exemplary language and results, it is to be understood that the inventive concept(s) is not limited in its application to the details of construction and the arrangement of the components set forth in the following description. The inventive concept(s) is capable of other embodiments or of being practiced or carried out in various ways. As such, the language used herein is intended to be given the broadest possible scope and meaning; and the embodiments are meant to be exemplary-not exhaustive. Also, it is to be understood that the phraseology and terminology employed herein is for the purpose of description and should not be regarded as limiting.

Unless otherwise defined herein, scientific and technical terms used in connection with the presently disclosed inventive concept(s) shall have the meanings that are commonly understood by those of ordinary skill in the art. Further, unless otherwise required by context, singular terms shall include pluralities and plural terms shall include the singular. The foregoing techniques and procedures are generally performed according to conventional methods well known in the art and as described in various general and more specific references that are cited and discussed throughout the present specification.

All patents, published patent applications, and non-patent publications mentioned in the specification are indicative of the level of skill of those skilled in the art to which this presently disclosed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the compositions, assemblies, systems, kits, and/or methods disclosed herein can be made and executed without undue experimentation in light of the present disclosure. While the compositions, assemblies, systems, kits, and methods of the inventive concept(s) have been described in terms of particular embodiments, it will be apparent to those of skill in the art that variations may be applied to the compositions and/or methods and in the steps or in the sequence of steps of the methods described herein without departing from the concept, spirit, and scope of the inventive concept(s). All such similar substitutions and modifications apparent to those skilled in the art are deemed to be within the spirit, scope, and concept of the inventive concept(s) as defined by the appended claims.

As utilized in accordance with the present disclosure, the following terms, unless otherwise indicated, shall be understood to have the following meanings:

The use of the term “a” or “an” when used in conjunction with the term “comprising” in the claims and/or the specification may mean “one,” but it is also consistent with the meaning of “one or more,” “at least one,” and “one or more than one.” As such, the terms “a,” “an,” and “the” include plural referents unless the context clearly indicates otherwise. Thus, for example, reference to “a compound” may refer to one or more compounds, two or more compounds, three or more compounds, four or more compounds, or greater numbers of compounds. The term “plurality” refers to “two or more.”

The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

The use of the term “or” in the claims is used to mean an inclusive “and/or” unless explicitly indicated to refer to alternatives only or unless the alternatives are mutually exclusive. For example, a condition “A or B” is satisfied by any of the following: A is true (or present) and B is false (or not present), A is false (or not present) and B is true (or present), and both A and B are true (or present).

As used herein, any reference to “one embodiment,” “an embodiment,” “some embodiments,” “one example,” “for example,” or “an example” means that a particular element, feature, structure, or characteristic described in connection with the embodiment is included in at least one embodiment. The appearance of the phrase “in some embodiments” or “one example” in various places in the specification is not necessarily all referring to the same embodiment, for example. Further, all references to one or more embodiments or examples are to be construed as non-limiting to the claims.

Throughout this application, the terms “about” or “approximately” are used to indicate that a value includes the inherent variation of error for a composition/apparatus/device, the method being employed to determine the value, or the variation that exists among the study subjects. For example, but not by way of limitation, when the term “about” is utilized, the designated value may vary by plus or minus twenty percent, or fifteen percent, or twelve percent, or eleven percent, or ten percent, or nine percent, or eight percent, or seven percent, or six percent, or five percent, or four percent, or three percent, or two percent, or one percent from the specified value, as such variations are appropriate to perform the disclosed methods and as understood by persons having ordinary skill in the art.

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. For example, the term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), field programmable gate array (FPGA), a combination of hardware and software, and/or the like. The term “processor” as used herein means a single processor or multiple processors working independently or together to collectively perform a task.

Software may include one or more computer readable instructions that when executed by one or more components cause the component to perform a specified function. It should be understood that the algorithms described herein may be stored on one or more non-transitory memory. Exemplary non-transitory memory may include random access memory, read only memory, flash memory, and/or the like. Such non-transitory memory may be electrically based, optically based, and/or the like.

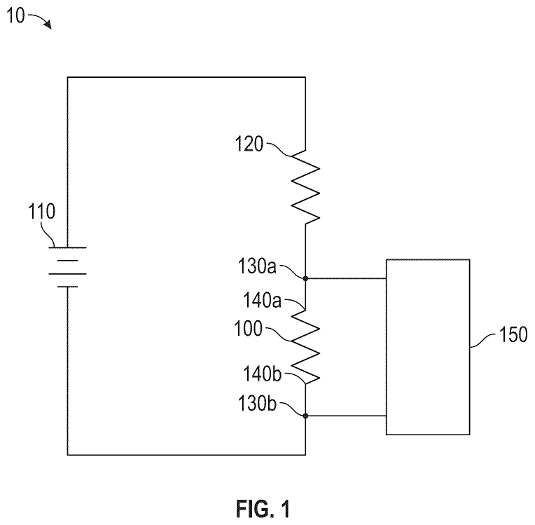

Referring now to the drawings, and in particular to FIG. 1, shown therein is an exemplary force measurement circuit 10 having a force-sensing resistor 100 (hereinafter “force sensor 100”) in accordance with the present disclosure. In some embodiments, the measurement circuit 10 may include an electrical source 110 configured to apply a voltage across both a resistor 120 and the force sensor 100 in series with the resistor 120. The measurement circuit 10 may include a first node 130a disposed at a first side 140a of the force sensor 100, and a second node 130b disposed at a second side 140b of the force sensor 100. A reader 150 may be electrically coupled to the first node 130a and the second node 130b and configured to detect a voltage across the force sensor 100. Utilizing the voltage divider rule, a resistance of the force sensor 100 can be derived from the measured voltage, the known input voltage, and the known resistance of the resistor 120. As a force is applied to the force sensor 100, the force sensor 100 deforms and its resistance changes proportionally to the force applied. Thus, the reader 150 may be configured to detect this change in resistance and calculate the proportional force being applied to the force sensor 100.

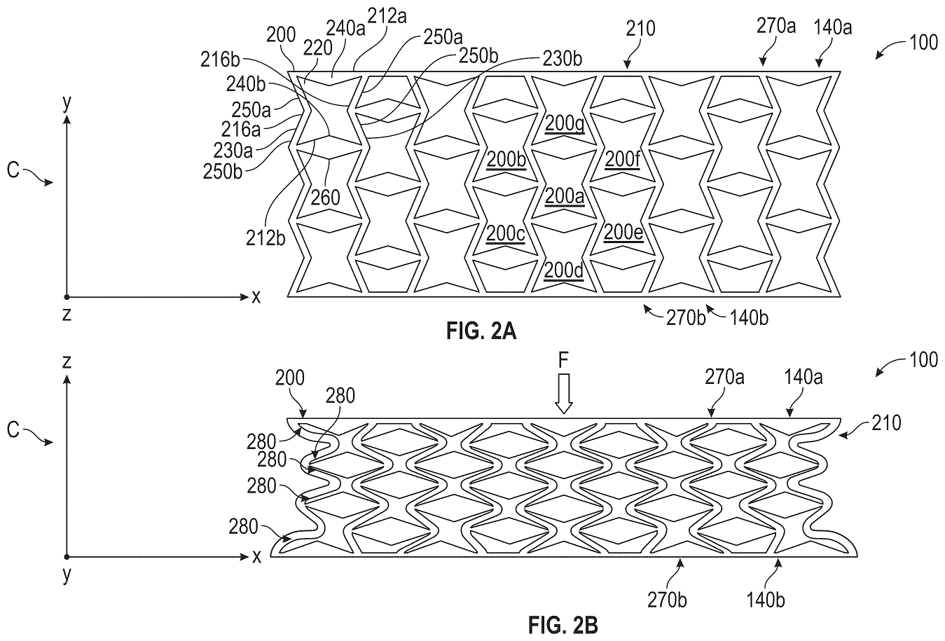

Turning to FIGS. 2A and 2B, the force sensor 100 in accordance with the present disclosure may be an auxetic force sensor 100. An “auxetic” force sensor 100, as used herein, refers to a force sensor 100 having a negative Poisson's ratio. That is, as a compressive force is applied to a first axis of the force sensor 100, a thickness of the force sensor 100 along the first axis and a second axis orthogonal to the first axis is reduced. The force sensor 100 may thus be characterized as auxetic with respect to the second axis.

To illustrate, a coordinate system C shown in FIGS. 2A and 2B will be referred to herein with respect to the force sensor 100. The force sensor 100 may have an axis y, an axis x orthogonal to axis y, and an axis z (normal to the page) orthogonal to both axis y and axis x. As shown in FIG. 2B, the force sensor 100 may be auxetic with respect to the x axis. That is, as a compressive force F is applied along axis y, the thickness of the force sensor 100 is reduced along axis y, as well as axis x. In some embodiments, the force sensor 100 may be auxetic with respect to only axis y, axis x, or axis z; with respect to axis y and axis x; with respect to axis y and axis z; with respect to axis x and axis z; with respect to all of axis y, axis x, and axis z, or with respect to any combination thereof. In other embodiments, the force sensor 100 may alternatively or additionally be auxetic with respect to any additional axis oblique to any of axis y, x, and z.

An auxetic force sensor 100 may be comprised of an array of adjacently-disposed auxetic cells 200. In one non-limiting embodiment, the array may be a 2D array 210 of auxetic cells 200. In such an implementation, the 2D array 210 of such may be arranged in the x-y plane, with each auxetic cell 200 (and thus, the 2D array 210) having a depth extending parallel to the z axis. Each auxetic cell 200 may be auxetic with respect to the x axis such that, when a compressive force is applied to each cell along the y axis, a thickness of the individual auxetic cell 200 is reduced along the x axis.

Each auxetic cell 200 may have a top 212a, a bottom 212b opposite the top 212a, a first side 216a, a second side 216b, and a hollow core 220. Each auxetic cell 200 may have a plurality of walls surrounding the hollow core 220 including an upper wall 240a and a lower wall 240b, and sidewalls 230 extending between the upper wall 240a and the lower wall 240b including a first sidewall 230a a second sidewall 230b. The upper wall 240a may define the top 212a of the respective auxetic cell 200, and the lower wall 240b may define the bottom 212b of the respective auxetic cell 200.

The sidewalls 230a and 230b of each auxetic cell 200 may be configured to collapse inwardly in response to a compressive force being applied to at least one of the top and bottom of the auxetic cell 200. In one embodiment, each sidewall 230a and 230b may respectively have an upper sidewall portion 250a and a lower sidewall portion 250b coupled to the upper sidewall portion 250a. For each sidewall 230a and 230b, the upper sidewall portion 250a may be hingedly connected at one end to the upper wall 240a, and at the other end to the lower sidewall portion 250b. The lower sidewall portion 250b, being hingedly connected to the upper sidewall portion 250a at one end, may be hingedly connected to the lower wall 240b at the other end. In one embodiment, the upper sidewall portion 250a and the lower sidewall portion 250b may be coupled to one another at an angle re-entrant to the respective auxetic cell 200.

In some embodiments, vertically adjacent auxetic cells 200 may share all or a portion of the upper wall 240a/lower wall 240b. For example, the lower wall 240b of a first auxetic cell 200 may form the upper wall 240a of a second auxetic cell 200 below the first auxetic cell 200. In other embodiments, the lower wall 240b of the first auxetic cell and the upper wall 240a of the second auxetic cell disposed below the first auxetic cell may be combined to each form a portion of a horizontal strut 260. The 2D array 210 may have a plurality of horizontal struts 260 interconnecting auxetic cells 200.

In some embodiments, neighboring auxetic cells 200 may share at least a portion of a sidewall 230a/230b. For example, at least a portion of a second sidewall 230b of a first auxetic cell 200 may form at least a portion of a first sidewall 230a of a second, neighboring auxetic cell 200.

In some embodiments, neighboring columns of auxetic cells 200 of the 2D array 210 may be vertically offset in a manner sufficient to interconnect auxetic cells 200. In one particular implementation, neighboring columns of auxetic cells 200 of the 2D array 210 may be vertically offset by approximately a half-cell height. In such an implementation, an exemplary auxetic cell 200a surrounded by neighboring auxetic cells 200 may be surrounded by, for example, an upper-left auxetic cell 200b, a lower-left auxetic cell 200c, a lower auxetic cell 200d, a lower-right auxetic cell 200e, an upper-right auxetic cell 200f, and an upper auxetic cell 200g. In such an example, the exemplary auxetic cell 200a may have an upper sidewall portion 250a of a first sidewall 230a forming a lower sidewall portion 250b of a second sidewall 230b of the upper-left neighboring auxetic cell 200b; a lower sidewall portion 250b of the first sidewall 230a forming an upper sidewall portion 250a of a second sidewall 230b of the lower-left neighboring auxetic cell 200c; an upper sidewall portion 250a of a second sidewall 230b forming a lower sidewall portion 250b of a first sidewall 230a of the upper-right neighboring auxetic cell 200e; and a lower sidewall portion 250b of a second sidewall 230b forming the upper sidewall portion 250a of a first sidewall 230a of a lower-right neighboring auxetic cell 200d.

The force sensor 100 may be formed of one or more conductive materials such that a voltage may be applied across the force sensor 100 from the first side 140a to the second side 140b, or from the second side 140b to the first side 140a. The one or more conductive materials may be any conductive and elastic material. In some implementations, the one or more conductive materials may be conductive thermoplastic polyurethane (“TPU”). The force sensor 100 may be formed entirely or partially of the one or more conductive materials, may be formed of one or more non-conductive materials (such as non-conductive TPU) and may be formed of any combination of conductive and non-conductive materials. The first side 140a and the second side 140b of one implementation of a force sensor 100 may differ from another implementation of a force sensor 100 depending upon conductive structure of the respective force sensor 100.

In one implementation, the force sensor 100 may be formed entirely of conductive material. In such an implementation, the first side 140a may be a top side 270a of the force sensor 100, and the second side 140b may be a bottom side 270b of the force sensor 100. Thus, the force sensor 100 may be configured such that current may be passed from the top side 270a to the bottom side 270b.

As the force sensor 100 is compressed by, for example, a force F, the conductive material of the force sensor 100 may form new points of contact 280. New points of contact 280 may be caused by the internal buckling of sidewalls 230a/230b of the respective auxetic cells 200. For example, new points of contact 280 may be formed between an upper sidewall portion 250a and a lower sidewall portion 250b of a sidewall 230a/230b, between a sidewall 230a/230b and an upper wall 240a, or between a sidewall 230a/230b and a lower wall 240b.

In some implementations, the force sensor 100 may gradually form new points of contact 280 as the force sensor 100 is compressed. In some implementations, the number of new points of contact 280 may increase proportional to the compression of the force sensor 100.

The formation of new points of contact 280 may in turn form new conductive paths from the first side 140a to the second side 140b of the force sensor 100. At least some of the new conductive paths formed by new points of contact 280 may be shorter conductive paths or lower-impedance paths than conductive paths of the force sensor in an uncompressed state. Thus, a resistance across the force sensor 100 may decrease as the force sensor 100 is compressed and new points of contact 280 are formed.

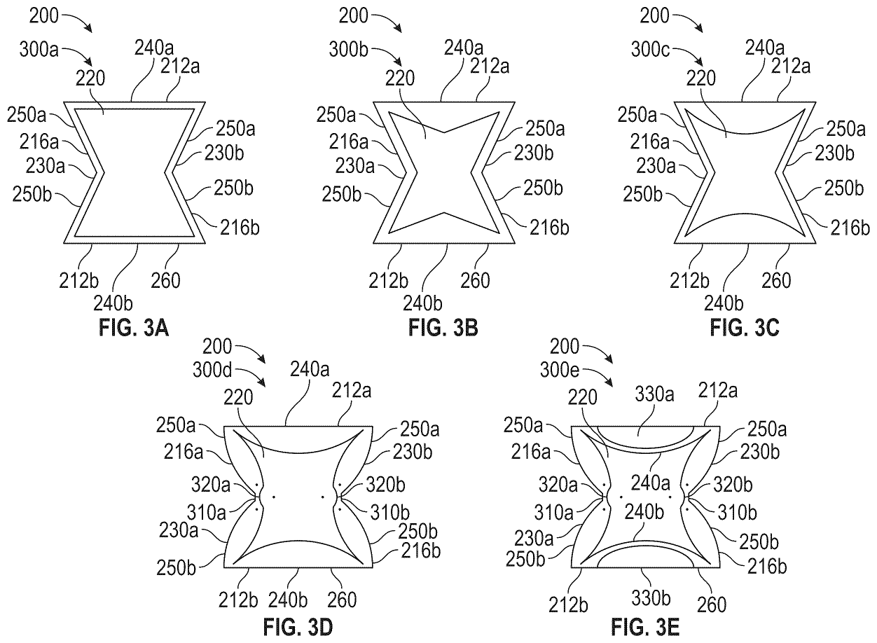

Turning to FIGS. 3A-3E, the auxetic cells 200 forming the 2D cell array 210 may have a variety of cell shapes 300, such as cell shapes 300a . . . 300e illustrated therein. A first cell shape 300a may be a polygonal partial-reentrant cell shape 300a wherein the upper wall 240a, the lower wall 240b, and the upper sidewall portion 250a and lower sidewall portion 250b of each of the respective first sidewall 230a and second sidewall 230b are substantially straight segments, and the first sidewall 230a and the second sidewall 230b are angularly reentrant to the auxetic cell 200.

A second cell shape 300b may be similar to the polygonal first cell shape 300a except that the second cell shape may be a polygonal full-reentrant cell shape 300b having a convexly formed upper wall 240a and lower wall 240b, such that the upper wall 240a and lower wall 240b are angularly shaped to extend inwards or be reentrant with respect to the center of the auxetic cell 200.

A third cell shape 300c may be similar to the second cell shape 300b, except that the third cell shape may be a partially curved full-reentrant cell shape 300c. In the partially curved reentrant cell shape 300c, the upper wall 240a and the lower wall 240b of the third cell shape 300c may have a curved rather than angular shape.

A fourth cell shape 300d may be formed similarly to the third cell shape 300c, except that the fourth cell shape 300d may be a curved full-reentrant cell shape 300d. Thus, the first sidewall 230a and the second sidewall 230b may have a curved reentrant geometry. That is, the upper sidewall portion 250a and lower sidewall portion 250b of each of the first sidewall 230a and second sidewall 230b may be curved at least on a side facing the hollow core 220. In some instances, the upper sidewall portions 250a and lower sidewall portions 250b may have a substantially elliptical shape.

The partially-curved and curved full-reentrant cell shapes 300c and 300d have been found to advantageously improve deformation of the auxetic cell 200. The additional material of a curved reentrant wall as opposed to an angular reentrant or non-reentrant wall promotes a more gradual increase in the formation of new points of contact 280 as the auxetic cell 200 is compressed and advantageously mitigates buckling of the sidewalls 230a/230b. This increases a rigidity of the auxetic cell 200, and results in a finer detection of changes in force.

In some instances, it may be desirable to reduce the rigidity of the auxetic cell while maintaining the advantageous properties of a curved reentrant sidewall 230a/230b. Thus, optionally, the first sidewall 230a and second sidewall 230b may each include a respective hinge 310a/310b connecting respective upper sidewall portions 250a with lower sidewall portions 250b and operable to support the inward collapsing movement of the first sidewall 230a and the second sidewall 230b. The hinges 310a/310b may be in the form of a material portion of each sidewall 230a/230b having a respective notch 320a/320b disposed therein. The respective notch 320a/320b may be contiguous with the hollow core 220, as shown.

A fifth cell shape 300e may be similar to the fourth cell shape 300d except that the upper wall 240a and the lower wall 240b may each have a void 330a/330b. The respective voids 330a/330b may be a hollowed-out portion of the respective upper wall 240a and lower wall 240b. In some instances, the voids 330a/330b may extend entirely to the end of the respective top 212a and bottom 212b of the auxetic cell 200. The voids 330a/330b may have any shape, such as circular, square, polygonal, elliptical, semi-circular, semi-elliptical or any fanciful shape.

The cell shapes 300a . . . 300e are mere examples of the forms of an auxetic cell 200, and any cell shape 300 sufficient to induce auxetic properties in a cell 200 is consistent with and included within the scope of this disclosure. For instance, any cell 200 having at least one sidewall 230 configured to collapse inwardly due to a compressive force applied to at least one of the top 212a and the bottom 212b of a cell 200.

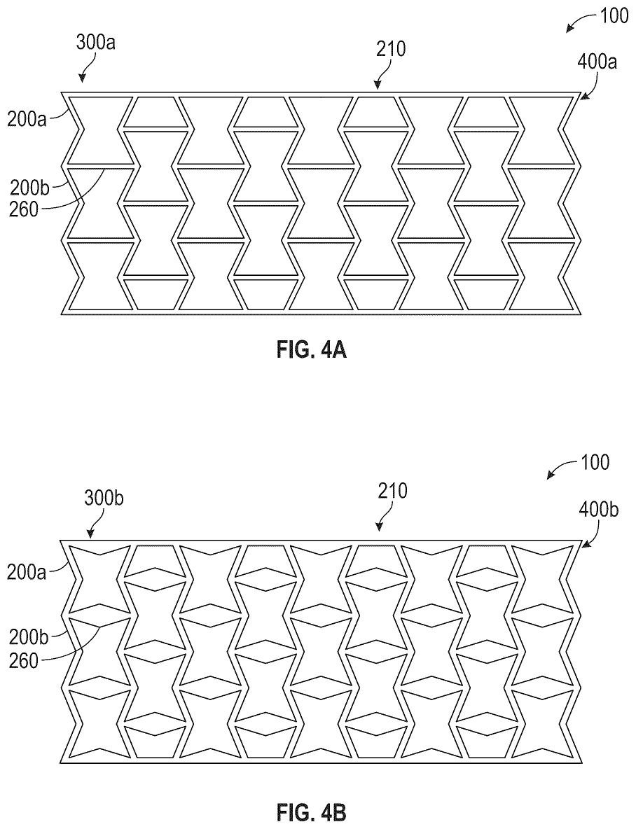

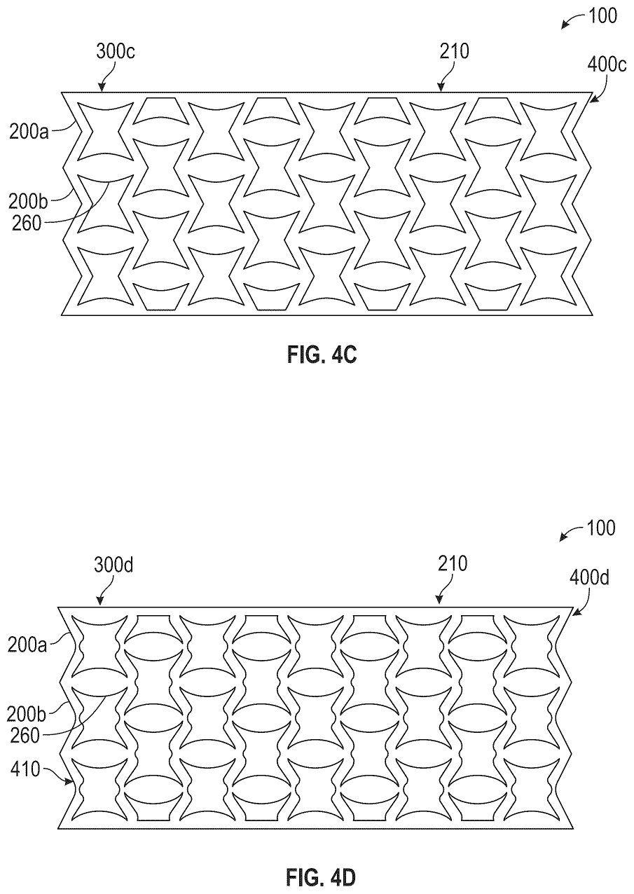

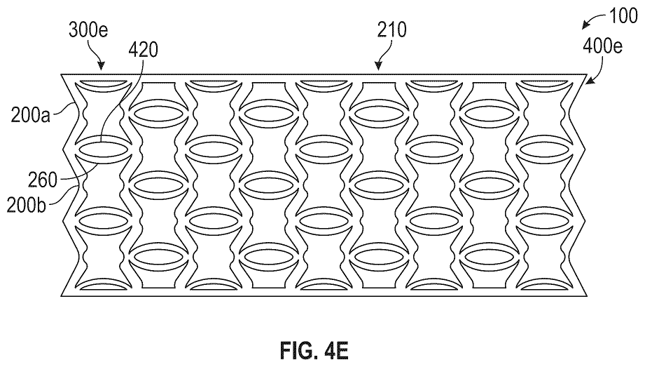

Referring now to FIG. 4A-4E, shown therein are 2D cell arrays 210 including exemplary 2D cell arrays 400a . . . 400e of a force sensor 100. The exemplary 2D cell arrays 400a . . . 400e may have auxetic cells 200 having respective cell shapes 300a . . . 300e described above. For example, a first exemplary 2D cell array 400a may comprise an array of auxetic cells 200 (such as exemplary cell 200a) having the first cell shape 300a which is the polygonal partial reentrant cell shape 300a described above. In the first 2D cell array 400a, the horizontal struts 260 may be formed by the respective upper wall 240a and lower wall 240b of adjacently stacked auxetic cells 200a/200b. In some implementations, the respective upper wall 240a of the lower auxetic cell 200b and the respective lower wall 240b of the higher auxetic cell 200a may be the same wall.

A second exemplary 2D cell array 400b may comprise auxetic cells 200 (such as exemplary auxetic cell 200a) having the second cell shape 300b, which is the polygonal full-reentrant cell shape 300b described above. In the second 2D cell array 400a, the horizontal struts 260 may be formed by a meeting of the respective upper wall 240a and lower wall 240b of adjacently stacked auxetic cells 200a/200b.

A third exemplary 2D cell array 400c may comprise auxetic cells 200 (such as exemplary auxetic cell 200a) having the third cell shape 300c, which is the partially curved full-reentrant cell shape 300c. The third exemplary 2D cell array 400c is similar to the second exemplary cell array 400b, except that the upper wall 240a and the lower wall 240b of each auxetic cell 200 are curved rather than angularly shaped, consistent with the description of cell shape 300c. Adjacently stacked auxetic cells such as auxetic cells 200a and 200b form elliptically shaped horizontal struts 260.

A fourth exemplary 2D cell array 400d may comprise an array of auxetic cells having the fourth cell shape 300d, which may be a curved full-reentrant cell shape 300d. In the fourth exemplary 3D cell array 400d, both the first sidewall 230a and the second sidewall 230b of each cell may have a curved reentrant geometry, such as a substantially elliptical shape, along with the curved upper wall 240a and lower wall 240b. In one implementation and shown in FIG. 4D, the perimeter 410 of the fourth exemplary 2D cell array 400d may comprise straight-edged walls, whereas walls internal to the perimeter 410 may include curved-edged walls. Further, auxetic cells 200 in the 2D cell array 400d may optionally include a respective hinge 310a/310b with a notch 320a/320b in each sidewall to reduce rigidity while maintaining the curved reentrant advantages.

A fifth exemplary 2D cell array 400e would comprise an array of auxetic cells having the fifth cell shape 300e. This array is similar to the fourth cell array 400d, but the upper wall 240a and the lower wall 240b of each cell each include a respective void 330a/330b. When auxetic cells 200, such as auxetic cells 200a and 200b, are adjacently stacked in the 2D array, the respective voids 330a/330b from the upper wall of a lower cell and the lower wall of a higher cell may combine to form a combined void 420 in the respective horizontal strut 260.

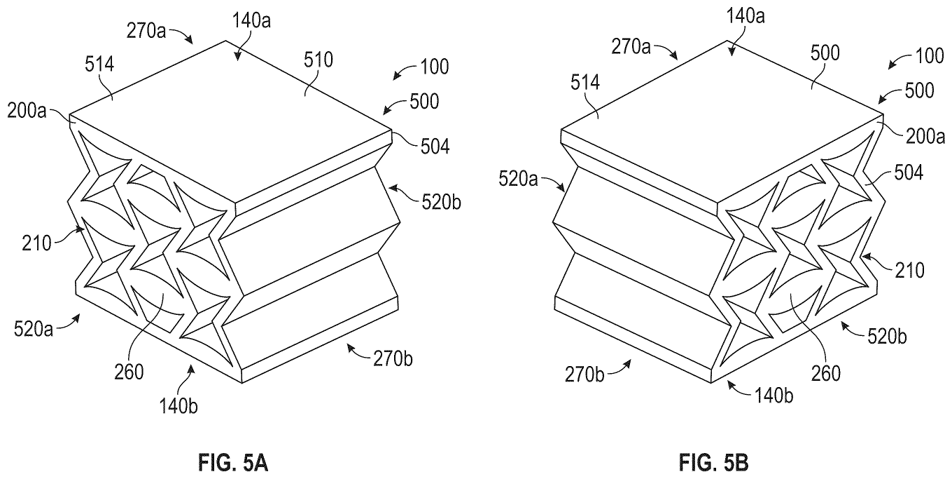

Turning to FIGS. 5A and 5B, a force sensor 500 is shown therein. The force sensor 500 may be an implementation of the force sensor 100 including a first embodiment of a body 504. The body 504 may be formed of a 2D cell array 210 (which may be any exemplary 2D cell array 400a . . . 400e) having a depth along the z axis (see coordinate system C in FIG. 2A/2B). The body 504 may be formed of one or more conductive materials 510 (such as conductive TPU) forming a conductive body 514. In the first embodiment, the body 504 is entirely formed of the one or more conductive materials 510 such that the conductive body 514 is the body 504. The body 504 may have a front face 520a and a rear face 520b reverse to the front face 520a. The 2D cell array 210 may extend from the front face 520a to the rear face 520b.

In the first embodiment of the body 504, the first side 140a may be the top side 270a and the second side 140b may be the bottom side 270b. That is, an electrical source 110 may be coupled to the body 504 at the top side 270a and the bottom side 270b such that a voltage is applied across the body 504.

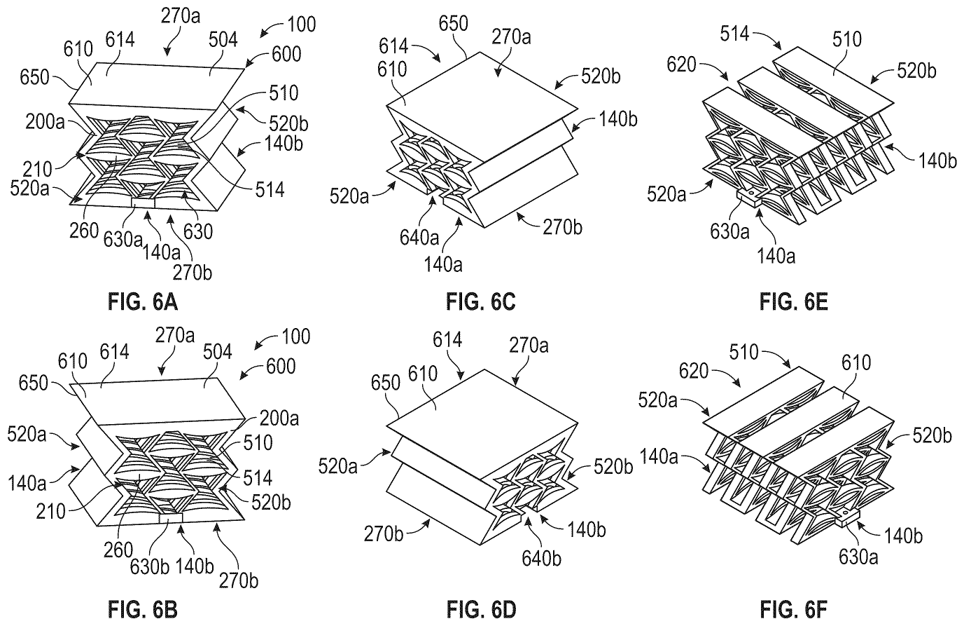

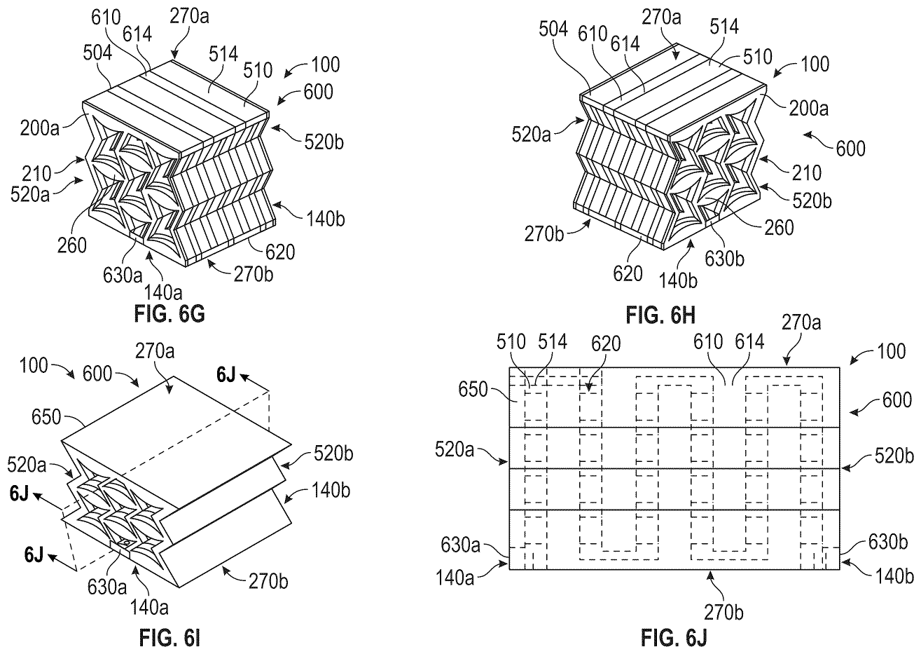

Turning to FIGS. 6A-6J, a force sensor 600 is shown therein. The force sensor 600 may be an implementation of the force sensor 100 including a second embodiment of the body 504. The second embodiment of the body 504 may be similar to the first embodiment of the body 504, except the second embodiment of the body 504 is formed of the one or more conductive materials 510 forming the conductive body 514, and one or more non-conductive materials 610 (which may be non-conductive TPU) forming a non-conductive body 614. The body 504 of the force sensor 600 may be formed by interlacing the conductive body 514 and the non-conductive body 614 forming a sinuous conductive pathway 620 therethrough. The sinuous conductive pathway 620 may be formed by the conductive body 514 extending from a first conductive terminal 630a disposed in a first terminal slot 640a of the non-conductive body 614 at the front face 520a to a second conductive terminal 630b disposed in a second terminal slot 640b of the non-conductive body 614 at the rear face 520b. In such an implementation, the first conductive terminal 630a may be the first side 140a of the force sensor 600 and the second conductive terminal 630b may be the second side 140b of the force sensor 600. That is, a voltage may be applied across the force sensor 600 by coupling the electrical source 110 to the first conductive terminal 630a and the second conductive terminal 630b.

In some implementations, the non-conductive body 614 may also form an insulating outer shell 650 over the conductive body 514, such that only the conductive terminals 630a/630b in terminal slots 640a/640b are exposed to the environment. Advantageously, this may prevent a leakage of current outside of the force sensor 600, improving force detection accuracy.

For purposes of demonstration, FIGS. 6G and 6H show the force sensor 600 without the insulating outer shell 650, illustrating the sinuous conductive path 620 typically disposed therewithin. FIG. 6J illustrates a cross-sectional view of the force sensor 600 taken along plane 6J-6J of FIG. 6I. As shown, the sinuous conductive path 620 extends between the first conductive terminal 630a at the front face 520a and the second conductive terminal 630b at the rear face 530b. As opposed to the first embodiment of the body 504, wherein the whole body 504 is the conductive body 514, the second embodiment of the body 504 extends the length of travel of current between the first side 140a and the second side 140b. Advantageously, this has been found to result in finer detection of changes in resistivity as the force sensor 600 is compressed, improving the sensitivity of the force sensor 600.

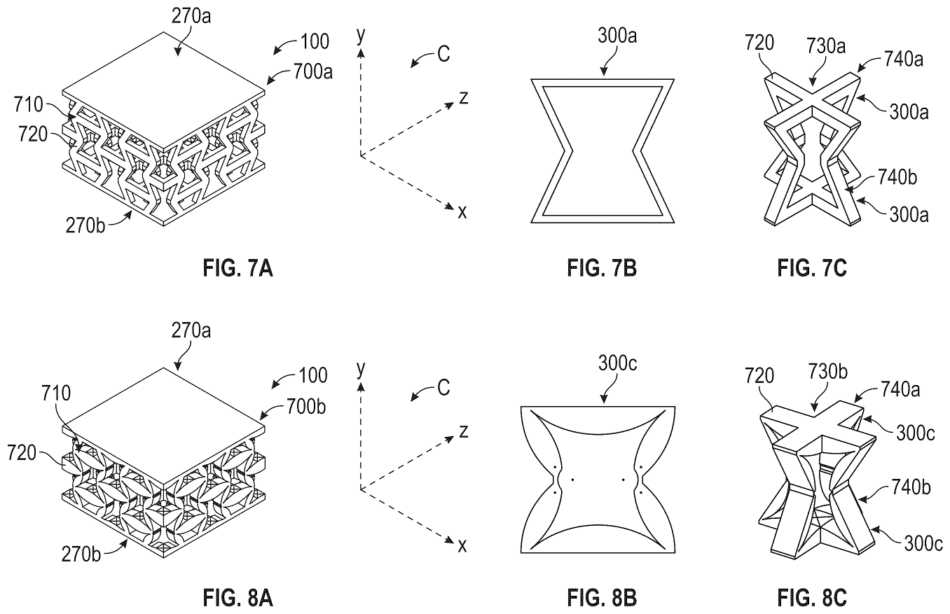

Referring now to FIGS. 7A-7C and FIGS. 8A-8C, the force sensor 100 in accordance with the present disclosure may be embodied as a force sensor 700 having a 3D cell array 710 of auxetic cells 720. The auxetic cells 720 may be similar to the auxetic cells 200 above, except that the auxetic cells 720 exhibit auxetic behavior along two or more non-parallel axis, such as the x axis and the z axis of coordinate system C. In some implementations, the auxetic cells 720 of the 3D cell array 710 may be disposed throughout the volume of the force sensor 700, such as along the x-y plane and the y-z plane. Thus, the force sensor 700 may be auxetic with respect to the x axis and z axis in response to a compressive force along the y axis.

Each auxetic cell 720 may have a cell shape 730. The cell shape 730 of a particular auxetic cell 720 may be envisaged as two overlapping, orthogonal cell shapes 740, which may be cell shapes 300 described above. The overlapping, orthogonal cell shapes 740 may include a first overlapping cell shape 740a and a second overlapping cell shape 740. Thus, the 3D cell array 700 may also be envisaged as two overlapping, orthogonal 2D cell arrays 210.

For example, the force sensor 700 may be constructed as the force sensor 700a of FIG. 7A. The force sensor 700a may have a 3D cell array 710 of cells 720 having cell shape 730a. As shown in FIG. 7C, the first overlapping cell shape 740a may be the first cell shape 300a, and the second overlapping cell shape 740b may also be the first cell shape 300a orthogonal to the first overlapping cell shape 740a.

In another example, the force sensor 700 may be constructed as the force sensor 700b of FIG. 8A. The force sensor 800 may be similar to the force sensor 700 except that the force sensor 800 may have a cell shape 730b wherein the first overlapping cell shape 740a is the third cell shape 300c and the second overlapping cell shape 740b is also the third cell shape 300c.

The force sensor 700 may also have any other cell shape 730 operable to cause internal buckling of the cell walls in response to a compressive force. The first overlapping cell shape 740a may be the same cell shape 300 or a different cell shape 300 than the second overlapping cell shape 740b.

The force sensor 700 may be constructed of one or more conductive materials (such as conductive TPU), one or more non-conductive materials (such as non-conductive TPU), or a combination of conductive materials and non-conductive materials. The force sensor 700 may be constructed of conductive materials and non-conductive materials such that the force sensor 700 includes a sinuous conductive path 620 disposed therein, similarly to the force sensor 600 described above.

The force sensor 100 including the above-described embodiments and implementations thereof may be constructed by a fused deposition modeling (FDM) 3D-printing method. In some embodiments, a dual nozzle 3D printer may be utilized, such as a Raised3D E2 dual nozzle 3D printer, as well as a slicer such as IdeaMaker, to prepare and run the prints. The conductive material of the force sensor 100 may be formed of a conductive filament such as conductive TPU, which may be specifically Ninjatek Eel TPU filament.

Particularly, the force sensor 500 may be constructed by 3D-printing by printing the entire force sensor body 504 entirely with the one or more conductive materials 510. Electrical connective means (such as wires, terminals, etc.) may be attached to the top 270a and bottom 270b of the printed body 504 to allow voltage to be applied across the force sensor 500.

The force sensor 600 may be constructed by printing a composite structure involving both one or more conductive materials 510 and a one or more non-conductive material 610. A conductive filament and a non-conductive filament is used to create a looping path. In some implementations, the conductive body 514 may be offset from the non-conductive body 614 by 8 millimeters from the non-conductive body 614 so that the conductive body 514 interlocks with and fits inside the non-conductive body 614. The non-conductive body 614 and the conductive body 514 may be joined during the 3D printing process as the conductive material 510 and the non-conductive material 610 may have similar properties, allowing the materials to adhere. In some designs, the non-conductive body 614 may be printed to form an insulating outer shell over the conductive body 514. The force sensor 600 may be printed to have terminals 630a/630b. Following printing, electrical connective means may be coupled to the terminals to allow voltage to be applied across the force sensor 600.

The force sensor 700 may have increased complexity over the force sensors 500/600. Thus, supports may be required to prevent collapse of the force sensor 700 during printing. Supports may be required only during the printing process, and therefore should be removable from the structure. In some implementations, the supports may be dissolvable, and thus a water-soluble HIPs filament may be used as the supporting material. In one particular implementation, the water-soluble filament may be any commercially available dissolvable polyvinyl alcohol (“PVA”). After printing, the force sensor 700 may be submerged in a water bath for 12-36 hours (preferably about 24 hours) so that the supports dissolve. Following dissolution, the force sensor 700 may be permitted to dry for a period of 12-36 hours (preferably about 24 hours) to ensure all residual moisture is removed. Electrical connective means may then be coupled to the force sensor 700 such that a voltage may be applied across the force sensor 700.

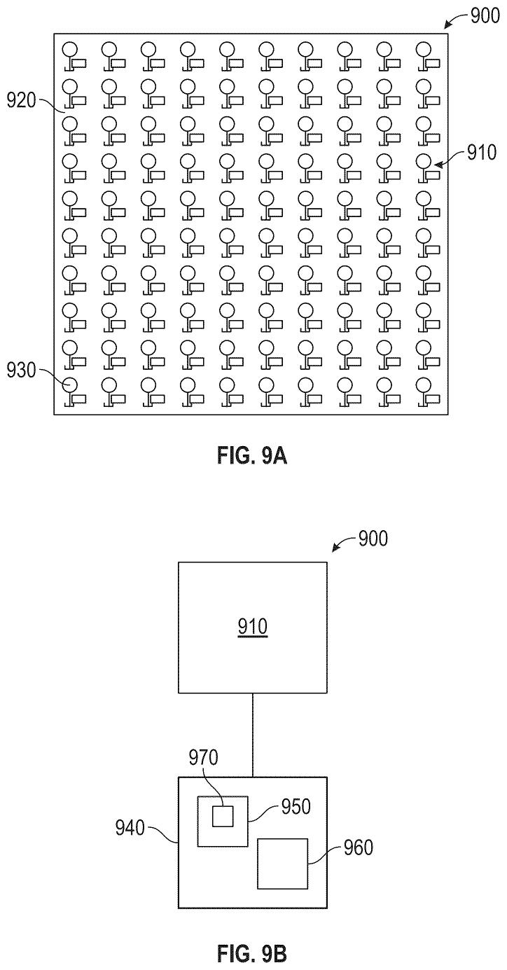

Turning to FIGS. 9A and 9B, the present disclosure includes an improved force-mapping system 900. In one implementation, the force-mapping system 900 may be utilized in measuring the weight-distribution of a human sitting in a car seat. Particularly, the force-mapping system 900 disclosed herein may be advantageously utilized for ergonomic analysis of autonomous-vehicle seating.

The force-mapping system 900 may include a force sensor array 910 coupled to a substrate 920. The force sensor array 910 may be an array of a plurality of force sensors 930 equidistantly disposed. In some implementations, the plurality of force sensors 930 may include one or more force sensors 100 described above, including force sensors 500, 600, and 700. The force sensor array 910 illustrated in FIG. 9 as a 10×10 matrix is merely illustrative, and the force sensor matrix 910 may have a number of force sensors 930 and resolution greater or lesser than is shown. The force sensor array 910 may be operable to generate a plurality of signals in the form of a force signal matrix 1100 from the plurality of force sensors 930.

In some implementations, the force-mapping system 900 may include a CPU 940 having at least one computer-readable medium 950 and at least one processor 960. The at least one computer-readable medium 950 may store computer-executable instructions 970 that, when executed by the processor 960, cause the processor 960 to receive the plurality of signals from the force sensor matrix 910 and generate data indicative of a distribution of force applied to the force sensor matrix 910. In some implementations, the data indicative of the distribution of force applied to the force sensor matrix 910 may be in the form of, or include, a force distribution map 1000. The force distribution map 1000 may be in the form of a heatmap indicating the distribution and magnitude of the force applied to each individual force sensor 930 of the force sensor matrix 910.

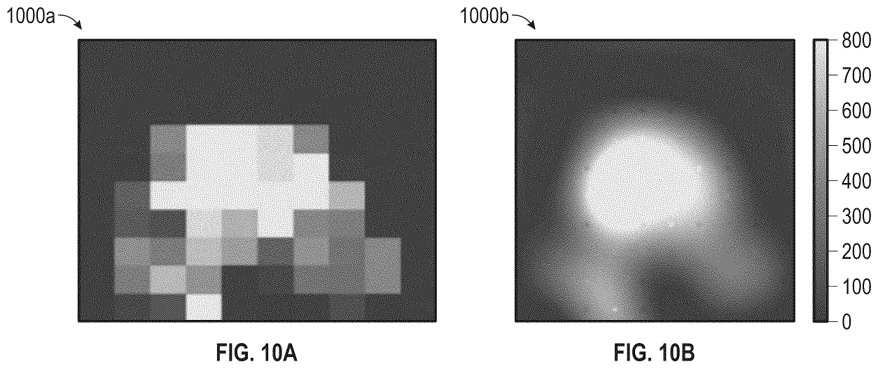

In some implementations, the force sensor matrix 910 may have a first resolution, and the force-mapping system 900 may be operable to generate a force distribution map 1000 at a second resolution greater than the first resolution. For example, FIG. 10A illustrates a lower resolution force distribution map 1000a (“LR-FDM”) generated from the plurality of signals from an exemplary force sensor array 910 at the first resolution, and FIG. 10B illustrates a higher resolution force distribution map 1000b (“HR-FDM”) generated from the same force signals but at a second resolution higher than the lower resolution force distribution map 1000a. In some implementations, the first resolution may be 5×5 or 10×10, and the second resolution may be 100×100.

To upscale the resolution from the force signal matrix 1100 generated by the force sensor array 910 to produce a force distribution map 1000 at the second resolution, the force-mapping system 900 may be operable to analyze the force signal matrix 1100 with a predetermined force distribution model. In one implementation, the predetermined force distribution model may include a super resolution generative adversarial network (“SRGAN”) trained to generate a higher resolution force distribution map 1000b from a lower resolution force distribution map 1000a.

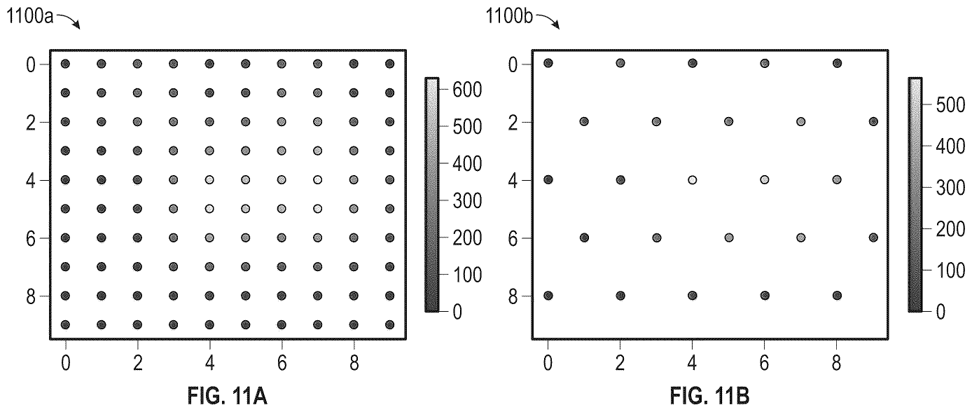

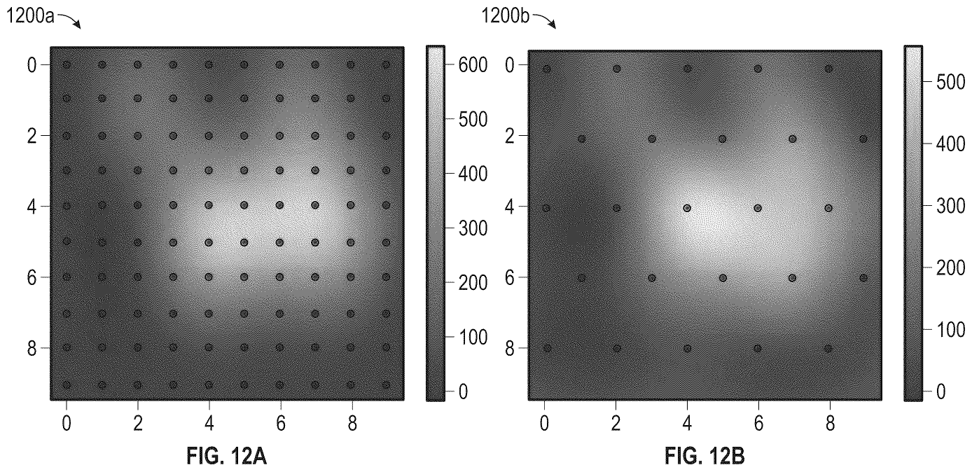

To train the SRGAN, a plurality of training sets may be generated. Turning to FIGS. 11A-12B, a plurality of 10×10 simulated force signal matrices 1100a and a plurality of 5×5 simulated force signal matrices 1100b may be generated. Each 5×5 simulated force signal matrices 1100b may have a triangulation layout and be generated by extracting the 5×5 simulated force signal matrix 1100b from a respective 10×10 force signal matrix 1100a. In some implementations, the simulated force signal matrices 1100a and 1100b may imitate the force distribution of a human sitting in a car seat.

From the simulated force signal matrices 1100a/1100b, respective simulated force distribution maps 1200a/1200b may be generated by a spatial interpolation method such as Kriging. By applying Kriging to the plurality of simulated force signal matrices 1100a/1100b, a plurality of high-resolution sample force distribution maps 1200a (HR-SFDM) and low-resolution sample force distribution maps 1200b (LR-SFDM) may be generated.

Thus, each training set may include one HR-SFDM 1200a and an associated LR-SFDM 1200b. The SRGAN is trained using these sample generated maps to learn the relationship required to up-scale a lower resolution force distribution map 1000a map to a higher resolution force distribution map 1000b. The trained SRGAN may include a force distribution model of the force mapping system 900. The force mapping system 900 may be operable to generate a LR-FDM 1000a from the force signal matrix 1100 via spatial interpolation (such as Kriging), and then upscale the LR-FDM 1000a to a HR-FDM 1000b with the force distribution model.

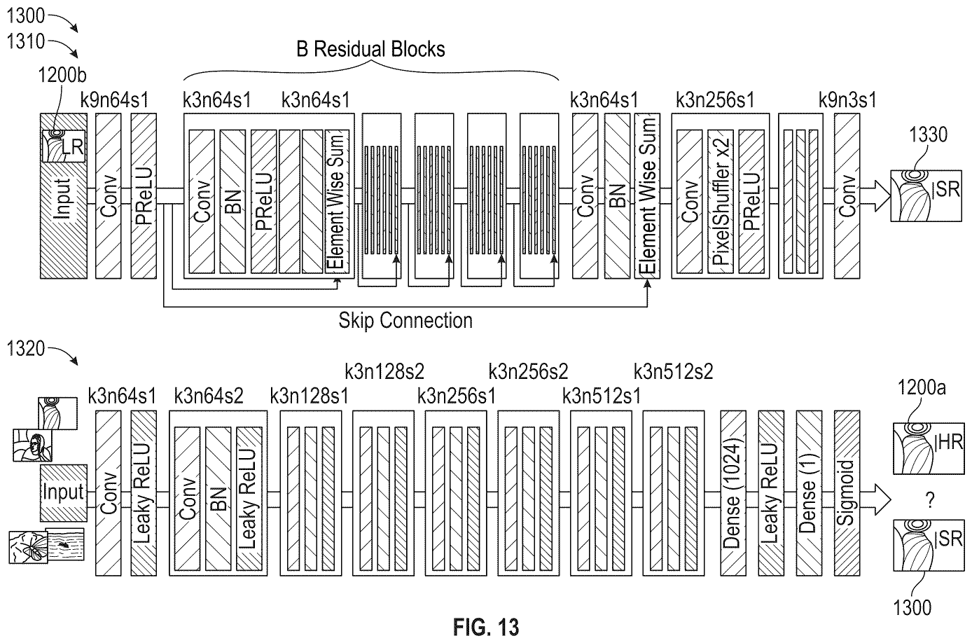

The SRGAN may be a SRGAN 1300 shown in FIG. 13, including a generator network 1310 (“GN 1310”) and discriminator network 1320 (“DN 1320”). The training process involves generating the plurality of training sets wherein each set includes a HR-SFDM 1200a and a corresponding LR-SFDM 1200b. The LR-SFDM 1200b serves as the input to the GN 1310, and the HR-SFDM 1200a serves as the ground truth image. The goal of the training is for the GN 1310 to learn the relationship required to up-scale the LR-FDM 1200b to an output 1330 which closely resembles the HR-FDM 1200a.

The DN 1320 acts as a classifier in the training process. Its role is to distinguish between the HR-SFDMs 1200a (the ground truth images) and the GN output images 1330 (the fake images). The DN 1320 is trained to output a high probability score when the input image is the HR-SFDM 1200a and a low probability score when the input image is the GN output image 1330.

SRGAN is trained by placing the GN 1310 and the DN 1320 in competition. The goal of the GN 1310 during the adversarial training process is to trick the DN 1320 into believing the GN output image 1330 is the HR-FSDM 1200b. The GN 1310 is optimized to generate images that maximize the DN 1320 error (i.e., make the DN 1320 think the generated images are real). Conversely, the DN 1320 is optimized to minimize its error (i.e., correctly classify the real HR-SFDMs 1200b and the fake generated images). This competitive feedback loop continues until the GN 1310 is able to generate high-resolution force distribution maps 1000b as GN output images 1330 that the DN 1320 can no longer reliably distinguish from the HR-SFDMs 1200a. The resulting trained GN 1310 therefore becomes the force distribution model capable of upscaling a lower resolution force distribution map 1000a (generated from a low resolution force signal matrix 1100) into a high-resolution force distribution map 1000b.

In some implementations, the HR-SFDMs 1200a and desired output images 1330 may be set to a higher resolution pixel count, such as 256×256 pixels, while the LR-FSDMs 1200b may be set to a lower resolution pixel count, such as 64×64 pixels. To be compatible with SRGAN model input, all input images may be transformed using bicubic interpolation and further transformed into tensors. The images may then be normalized such as with a mean of [0.485, 0.456, 0.406] and standard deviation of [0.229, 0.224, 0.225] to ensure the SRGAN 1300 receives consistent input data.

The architecture of the GN 1310 and the DN 1320 in one implementation may be as shown in FIG. 13, having the corresponding kernel size (k), number of features maps (n), and stride(s) as shown for each convolutional layer. The GN 1310 may have multiple layers of convolutional and deconvolutional operations designed to learn the mapping from lower resolution to higher resolution images. In addition, the GN 1310 may also incorporate a set of residual blocks, which includes several convolutional layers, each followed by a batch normalization layer and a Parametric Rectified Linear Unit (PReLU) activation function, to capture finer details and textures in the GN output images 1330.

The DN 1320 may include several convolutional layers, each followed by a batch normalization layer and a Leaky Rectified Linear Unit (ReLU) activation function. The DN 1320 may be designed to produce a probability score indicating the likelihood of the GN output image 1330 being real or fake.

The loss function used to train the SRGAN 1300 may have two main components: adversarial loss and content loss. The adversarial loss measures the mean squared error between the DN 1320 output for the GN output image 1330 and a tensor of ones (i.e., the “real” ground truth labels for the discriminator). The GN 1310 goal may be to minimize this loss to produce more realistic images for the discriminator. Meanwhile, content loss measures the sum of the magnitudes of the vectors in a space or L1 norm between the feature representations of the GN output image 1330 and the ground truth HR-SFDM 1200a, as calculated by a feature extractor network called VGG-19. The total loss for the generator is the sum of the content loss and 1×10−3 times the adversarial loss while the discriminator's loss is the sum of the adversarial losses for both the GN output images 1330 and the HR-SFDMs 1200a, divided by 2. Both the GN 1310 and DN 1320 may be trained using stochastic gradient descent, and the losses may be accumulated and averaged over each batch of data during training. While training, the GN 1310 minimizes the total loss while the DN 1320 tries to maximize the difference between the scores of the GN output images 1330 and the HR-SFDMs 1200a. This competitive training dynamic ultimately leads to the GN 1310 producing high-quality super-resolved HR-FDMs 1000b.

The following is a number list of non-limiting illustrative embodiments of the inventive concept disclosed herein:
1. A force sensor comprising: a plurality of interconnected cells with at least some of the cells at least partially constructed of a conductive material having an elastic property, and with the least some of the cells having a top, a bottom and at least one sidewall extending between the top and the bottom, the at least one sidewall configured to collapse inwardly due to a compressive force applied to the at least one of the top and the bottom of the at least some of the cells, the conductive material of the at least some of the cells being electrically connected wherein the compressive force changes the electrical resistance of the conductive material.
2. The force sensor of illustrative embodiment 1, wherein the at least some of the cells are at least partially constructed of a non-conductive material, the non-conductive material of a first cell of the at least some cells electrically isolating the conductive material of the first cell from the conductive material of a second cell of the at least some of the cells.
3. The force sensor of illustrative embodiment 2, wherein the first cell is positioned adjacent to the second cell.
4. The force sensor of illustrative embodiment 1, wherein the at least one sidewall of the at least some cells has a first portion hingedly connected to a second portion wherein a first compressive force applied to the at least one of the top and the bottom of the cell causes a first contact pattern between the first portion and the second portion, and wherein a second compressive force applied to the at least one of the top and the bottom of the cell causes a second contact pattern between the first portion and the second portion, the first contact pattern being different from the second contact pattern.
5. The force sensor of illustrative embodiment 1, wherein the at least one sidewall of the at least some cells has a first portion hingedly connected to a first horizontal strut and a second portion hingedly connected to a second horizontal strut, wherein a first compressive force applied to the at least one of the top and the bottom of the cell causes a first contact pattern between the first portion and the first horizontal strut and between the second portion and the second horizontal strut, and wherein a second compressive force applied to the at least one of the top and the bottom of the cell causes a second contact pattern between the first portion and the first horizontal strut and the second portion and the second horizontal strut, the first contact pattern being different from the second contact pattern.
6. The force sensor of illustrative embodiment 1, wherein the at least some of the cells include a first cell and a second cell, the first cell being at least partially nested with the second cell.
7. The force sensor of illustrative embodiment 1, wherein the at least some of the cells include a plurality of first cells and a plurality of second cells, the plurality of first cells having a first cell shape and the plurality of second cells having a second cell shape.
8. The force sensor of illustrative embodiment 7, wherein the plurality of first cells are spatially disposed in a first planar array along a first axis, and the plurality of second cells are spatially disposed in a second planar array along a second axis, wherein the plurality of first cells overlap the plurality of second cells.
9. The force sensor of illustrative embodiment 8, wherein the first axis and the second axis are orthogonal.
10. The force sensor of illustrative embodiment 7, wherein the first cell shape and second cell shape are the same.
11. The force sensor of illustrative embodiment 7, wherein the first cell shape is different than the second cell shape.
12. The force sensor of illustrative embodiment 1, wherein the at least one sidewall includes a notch configured to promote the inward collapse of the at least one sidewall.
13. A measurement circuit, comprising: the force sensor of illustrative embodiment 1; an electrical source electrically coupled to the conductive material of the force sensor and operable to supply a voltage across the force sensor; and a reader connected to the conductive material of the force sensor and operable to determine an electrical resistance of the conductive material of the force sensor, the reader being configured to correlate an electrical resistance of the conductive material of the force sensor with a particular compressive force applied to the force sensor.
14. A non-transitory computer readable medium comprising computer executable instructions that when executed by a processor cause the processor to: receive a plurality of force signals from a force sensor array having a plurality of force sensors generating the force signals, the plurality of force sensors within the force sensor array having a first resolution; and analyze the plurality of force signals with a predetermined force distribution model configured to provide data indicative of a distribution of force applied to the force sensor array, the data indicative of the distribution of force including a force distribution map having a second resolution greater than the first resolution.
15. The non-transitory computer readable medium of illustrative embodiment 14, wherein the force distribution map is indicative of a weight distribution of a human sitting in a seat of a car.
16. A method for generating a force distribution model, comprising: receiving a plurality of force signals from a force sensor array having a plurality of force sensors generating the force signals, the plurality of force sensors within the force sensor array being distributed in a pattern having a first resolution; spatially interpolating the plurality of force signals from the force sensor array to generate a first force distribution map at the first resolution; and analyzing the first force distribution map with an artificial intelligence model trained to generate the force distribution model configured to estimate a second force distribution map having a second resolution greater than the first resolution.
17. The method of illustrative embodiment 16, wherein the artificial intelligence model is a super resolution generative adversarial network.
19. The method of illustrative embodiment 16, further comprising: training the artificial intelligence model with a plurality of training sets, each of the plurality of training sets including a first sample force distribution map indicative of a first sample force signal matrix at the first resolution, and a second sample force distribution map indicative of a second sample force signal matrix at the second resolution; wherein the first sample force signal matrix is a lower resolution matrix extracted from the second sample force signal matrix.
20. The method of illustrative embodiment 18, wherein the first sample force distribution map is generated from the first sample force signal matrix by a spatial interpolation method, and the second sample force distribution map is generated from the second sample force signal matrix by the spatial interpolation method.
21. The method of illustrative embodiment 19, wherein the spatial interpolation method is a Kriging method.

### CONCLUSION

From the above description, it is clear that the inventive concepts disclosed herein is well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the scope and coverage of the inventive concepts disclosed and claimed herein.

What is claimed is:

1. A force sensor comprising:
a plurality of interconnected cells with at least some of the cells at least partially constructed of a conductive material having an elastic property, and with the least some of the cells having a top, a bottom and at least one sidewall extending between the top and the bottom, the at least one sidewall configured to collapse inwardly due to a compressive force applied to the at least one of the top and the bottom of the at least some of the cells, the conductive material of the at least some of the cells being electrically connected wherein the compressive force changes the electrical resistance of the conductive material.

2. The force sensor of claim 1, wherein the at least some of the cells are at least partially constructed of a non-conductive material, the non-conductive material of a first cell of the at least some cells electrically isolating the conductive material of the first cell from the conductive material of a second cell of the at least some of the cells.

3. The force sensor of claim 2, wherein the first cell is positioned adjacent to the second cell.

4. The force sensor of claim 1, wherein the at least one sidewall of the at least some cells has a first portion hingedly connected to a second portion wherein a first compressive force applied to the at least one of the top and the bottom of the cell causes a first contact pattern between the first portion and the second portion, and wherein a second compressive force applied to the at least one of the top and the bottom of the cell causes a second contact pattern between the first portion and the second portion, the first contact pattern being different from the second contact pattern.

5. The force sensor of claim 1, wherein the at least one sidewall of the at least some cells has a first portion hingedly connected to a first horizontal strut and a second portion hingedly connected to a second horizontal strut, wherein a first compressive force applied to the at least one of the top and the bottom of the cell causes a first contact pattern between the first portion and the first horizontal strut and between the second portion and the second horizontal strut, and wherein a second compressive force applied to the at least one of the top and the bottom of the cell causes a second contact pattern between the first portion and the first horizontal strut and the second portion and the second horizontal strut, the first contact pattern being different from the second contact pattern.

6. The force sensor of claim 1, wherein the at least some of the cells include a first cell and a second cell, the first cell being at least partially nested with the second cell.

7. The force sensor of claim 1, wherein the at least some of the cells include a plurality of first cells and a plurality of second cells, the plurality of first cells having a first cell shape and the plurality of second cells having a second cell shape.

8. The force sensor of claim 7, wherein the plurality of first cells are spatially disposed in a first planar array along a first axis, and the plurality of second cells are spatially disposed in a second planar array along a second axis, wherein the plurality of first cells overlap the plurality of second cells.

9. The force sensor of claim 8, wherein the first axis and the second axis are orthogonal.

10. The force sensor of claim 7, wherein the first cell shape and second cell shape are the same.

11. The force sensor of claim 7, wherein the first cell shape is different than the second cell shape.

12. The force sensor of claim 1, wherein the at least one sidewall includes a notch configured to promote the inward collapse of the at least one sidewall.

13. A measurement circuit, comprising:
the force sensor of claim 1;
an electrical source electrically coupled to the conductive material of the force sensor and operable to supply a voltage across the force sensor; and
a reader connected to the conductive material of the force sensor and operable to determine an electrical resistance of the conductive material of the force sensor, the reader being configured to correlate an electrical resistance of the conductive material of the force sensor with a particular compressive force applied to the force sensor.

14. A non-transitory computer readable medium comprising computer executable instructions that when executed by a processor cause the processor to:
receive a plurality of force signals from a force sensor array having a plurality of force sensors generating the force signals, the plurality of force sensors within the force sensor array having a first resolution; and
analyze the plurality of force signals with a predetermined force distribution model configured to provide data indicative of a distribution of force applied to the force sensor array, the data indicative of the distribution of force including a force distribution map having a second resolution greater than the first resolution.

15. The non-transitory computer readable medium of claim 14, wherein the force distribution map is indicative of a weight distribution of a human sitting in a seat of a car.

16. A method for generating a force distribution model, comprising:
receiving a plurality of force signals from a force sensor array having a plurality of force sensors generating the force signals, the plurality of force sensors within the force sensor array being distributed in a pattern having a first resolution;
spatially interpolating the plurality of force signals from the force sensor array to generate a first force distribution map at the first resolution; and
analyzing the first force distribution map with an artificial intelligence model trained to generate the force distribution model configured to estimate a second force distribution map having a second resolution greater than the first resolution.

17. The method of claim 16, wherein the artificial intelligence model is a super resolution generative adversarial network.

18. The method of claim 16, further comprising:
training the artificial intelligence model with a plurality of training sets, each of the plurality of training sets including a first sample force distribution map indicative of a first sample force signal matrix at the first resolution, and a second sample force distribution map indicative of a second sample force signal matrix at the second resolution;
wherein the first sample force signal matrix is a lower resolution matrix extracted from the second sample force signal matrix.

19. The method of claim 18, wherein the first sample force distribution map is generated from the first sample force signal matrix by a spatial interpolation method, and the second sample force distribution map is generated from the second sample force signal matrix by the spatial interpolation method.

20. The method of claim 19, wherein the spatial interpolation method is a Kriging method.
